(19) United States
(12) Patent Application Publication
(10) Pub. No.: US 2022/0033616 A1
(43) Pub. Date: Feb. 3, 2022

(54) COMPOSITION FOR USE IN 3D PRINTING

(71) Applicant: TE Connectivity Services GmbH, Schaffhausen 17601 (CH)

(72) Inventors: David Patrick ORRIS, Middletown, PA (US); Jessica H.B. Hemond, Mifflintown, PA (US)

(21) Appl. No.: 16/944,434

(22) Filed: Jul. 31, 2020

(51) Int. Cl. C08K 3/34; C08K 3/22; B33Y 70/00

(52) U.S. Cl. CPC C08K 3/346; C08K 2003/222; B33Y 70/00; C08K 3/22

(57) ABSTRACT

A photocurable polymer composition for use with a three dimensional printing process and a method of manufacture of such composition. The composition includes a photocurable resin and a filler and can be tunable to a desired dielectric constant. The filler comprises about 0 to about 30 weight percent of the composition.

### FIELD OF THE INVENTION

The present invention relates to a photocurable polymer composition used for three-dimensional printing which is tunable to a desired dielectric constant or dissipation factor.

### BACKGROUND OF THE INVENTION

Three-dimensional printing or additive manufacturing has become increasingly popular over the past several decades as a means of manufacturing prototypes as well as end user products. As the range of 3D products has become diverse, interest in developing printable materials that exhibit tunable properties such as conductivity or elasticity has increased. Nonetheless, the technology is still constrained as the product of a 3D printer is restricted by one or more of the materials that are combined into a given product.

Three-dimensional printing is a technique that cures material only where needed. Consequently, there is significantly less wasted material than in traditional manufacturing techniques. There is no need to mill or cut pieces in order to build a design shape as in traditional manufacturing techniques.

Two techniques used in three-dimensional printing are stereolithography (SLA) and digital light projection (DLP). Both of these techniques are based upon photopolymerizations. The strategy of these two methods is based upon light irradiation through a reservoir filled with photocurable materials.

SLA printing works by exposing a photosensitive liquid polymer resin to a light source. Typically, an ultraviolet (UV) laser is used. The light source rasters across the surface of the sample in a point by point or line by line fashion and introduces enough energy into the resin to induce photopolymerization resulting in the cross linking of the resin polymer to form a cohesive solid structure. Some SLA printers employ a top down approach in which the build plate is above the vat of resin and increases in height after each layer is cured. Other SLA printers employ a bottom up approach in which the build plate is in the resin and moves down after each layer is cured to expose the next layer of resin. This process results in smooth surfaces with highly detailed features.

DLP printers offer reduced printing times while maintaining high fabrication accuracy. In DLP printing, the cross- sectional area of each layer of the product is printed at once by projecting UV light onto a micromirror array that adjusts to form the pattern of the printed cross section. The DLP technology features the light source illuminating each layer all at once as opposed to SLA with point by point exposure.

U.S. Patent Publication No. 2014/0239527 describes a photocurable resin composition for use in three-dimensional printing. The composition includes a light-curable viscous mixture that includes 0-50% by weight of a poly(methyl methacrylate)/methyl methacrylate solution; 5-20% by weight of at least one kind of multifunctional aliphatic (meth)acrylate; 5-40% by weight of at least one kind of aliphatic urethane (meth)acrylate oligomer; 25-65% by weight of at least one kind of difunctional bisphenol-A dimethacrylate; 0.1 to 5% by weight of at least one kind of a photoinitiator; 0.05 to 2% by weight of at least one kind of light stabilizer; and 0.1 to 3% by weight of color pigment based on the total weight of the composition.

U.S. Pat. No. 9,902,860 describes a photopolymer composition for 3D printing using SLA/DLP technologies which has a low viscosity, proper cure rate, low volume shrinkage and low ash content. The composition comprises at least one polyfunctional (meth)acrylate monomer, at least one space filling monomer or organic compound, at least one (meth)acrylate monomer at least one photo-initiator and at least one light stabilizer.

The article “3D Printing a Mechanically-Tunable Acrylate Resin on a Commercial DLP-SLA Printer” by Borello et.al., describes how few material options exist for additive systems that employ vat photopolymerizations such as SLA and DLP 3D printers. In the article, the authors describe an acrylate photopolymer resin of facile and mechanically tunable formulations that is suitable for use with SLA and DLP 3D printing systems. The acrylate based resin consists of only a single monomer and crosslinker that is mechanically tunable.

The article “Photopolymerization in 3D Printing” by Bagheri et.al., describes how the field of 3D printing has opened up new implementation in rapid prototyping, tooling, dentistry, microfluidics, biomedical devices, drug delivery and other areas. The authors describe how 3D photopolymerizations is based on using monomers/oligomers in a liquid state that can be cured upon exposure to light of a specific wavelength. The authors conclude that developed photocurable formulations have shown great promise, there still needs to be work in tuning the properties of such materials.

Current photocurable polymer compositions do not allow for obtaining products that have satisfactory or desired dielectric constant. Thus, there is a need for a simple photocurable polymer composition which can be tunable to a desired dielectric constant or dissipation factor.

### SUMMARY OF THE INVENTION

An embodiment is directed to a photocurable polymer composition for use in a three-dimensional printing process. The photocurable polymer composition includes an ultraviolet curable resin with fillers. The ultraviolet curable resin is based upon an olefin.

An embodiment is directed to a photocurable polymer composition for use in a three-dimensional printing process wherein the ultraviolet curable resin is based upon acrylate or a modified acrylates.

An embodiment is directed to a method of forming the photocurable polymer composition which can be tunable to a desired dielectric constant and can be used for 3D printing.

An embodiment is directed to a part made using the photocurable polymer composition in a three-dimensional printer, wherein the desired dielectric constant can be obtained by tuning the fillers used in the photocurable polymer composition.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a flow diagram of an illustrative process of the present invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non- limiting combination of features that may exist alone or in other combinations of features, the scope of the invention being defined by the claims appended hereto.

The present invention relates to a novel photocurable polymer composition for use in three-dimensional printing which is tunable to a desired dielectric constant. The novel photocurable polymer composition comprises a photocurable resin with fillers dispersed in the photocurable resin. The novel photocurable polymer composition can be tuned to achieve the desired dielectric constant.

The dielectric constant of a material may be important for the desired end use of the material. The dielectric constant (k) of a material is the ratio of its permittivity [symbol] to the permittivity of vacuum. Consequently, the dielectric constant is therefore known as the relative permittivity of the material. A low-k dielectric material is a material that has a low ability to polarize or hold a charge. Low-k dielectric materials are generally good insulators. Low-k dielectric materials are preferred for high frequency or power applications to minimize electric power loss. High k-dielectric materials are good at holding a charge and are preferred materials for capacitors, or memory cells that store digital data in the form of a charge. The desired dielectric constant is determined based upon the end application of the novel photocurable polymer composition. Such determination is well within the skill of one of ordinary skill in the art.

Any photocurable resin that can be used in 3D printers can be used in this invention, including but not limited to UV curable olefins, UV curable epoxies and UV curable acrylates. Most preferably, the photocurable resin is based upon an acrylate. Alternatively, the photocurable resin can be a modified acrylate in which the backbone of the acrylate is modified to make it UV curable. Examples of such modified acrylates include epoxies or cyanate esters.

Examples of suitable photocurable resins that are commercially available include HT300 available from 3D Systems; CE 221 available from Carbon 3D; and Tough Black resin available from 3D Systems.

To achieve the desired dielectric constant, fillers are added to the photocurable resin. The desired dielectric constant is determined by the end use of the composition. Preferably, the dielectric constant is in the range of about 2.0 to about 5.9. The fillers are selected based upon the desired dielectric, the ability of the filler to disperse in the base resin, as well as printability of the composition. Fillers that agglomerate in the photocurable resin are not desired or preferred. In one embodiment, the filler is selected to achieve a target dielectric constant of about 3.8 with printability. Fillers may be selected to achieve other desired dielectric constants.

There are possibly two types of fillers that can be used in the composition: organic fillers and inorganic fillers. Examples of organic fillers include polyethylene (PE), polytetrafluoroethylene (PTFE), and polybutylene terephthalate (PBT). Examples of inorganic fillers include mica, magnesium oxide (MgO) and titanium dioxide (TiO₂). Preferred filler size and morphology will vary based upon the base resin and the filler combination. In one embodiment, a PE powder ranging in size from 40-48 micron was used, while in another embodiment, mica flake and MgO powder, both 325 mesh were used.

The range of the filler in the photocurable polymer composition is about 15 weight percent to about 40 weight percent. A single filler can be used in the photocurable polymer composition. However, it has however been found that a mixture of fillers enhances the electrical properties of the photocurable polymer composition while optimizing printability. An example of a mixture of fillers that can be used is a mixture (weight percent) of 28-32% mica and 8-12% magnesium oxide. To enhance printability, 10-15% titanium dioxide, 0.05-1% mica and 0.050-1% magnesium oxide can be used.

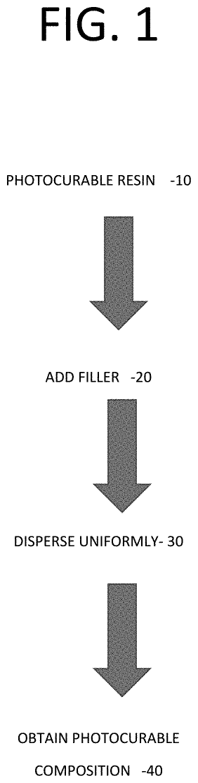

The photocurable polymer composition of the instant invention is formulated as shown by the block flow diagram of FIG.1. Liquid photocurable resin is added to a vessel. This step is shown as 10 in FIG.1. Filler is then added to the vessel as shown at 20 in FIG. 1. If more than one type of filler is used to make the photocurable polymer composition, the filler can all be combined by dry blending prior to the addition of the filler to the liquid resin. The liquid resin is then mixed with the fillers using centrifugal mixing so one can see that the filler is uniformly dispersed in the composition as shown at 30 in FIG.1. If there are issues with the uniformity of the mixture, dispersants such as polyacrylic acids may be added as an aid to the process. An example of a suitable dispersant is Dispex, available from BASF. Alternately, or in addition to the dispersant, a compatibilizer containing glycidyl methacrylate may also optionally be added to the composition. An example of such a compatibilizer is Lotader AX 8840 available from Arkema.

The time for mixing the resin with the filler is dependent upon the filler material. Care must be taken to make sure that heat is not generated during the process and crosslinking of the resin does not occur. The exact conditions for such mixing are well within the scope of one of ordinary skill in the art. A final photocurable composition is obtained as shown in 40 in FIG.1.

An example of a suitable mixer to be used in the process is a centrifugal mixer called a Flacktek speed mixer. Any other mixer which can uniformly disperse the filler in the resin can be used in the process.

The photocurable polymer composition can be processed into various objects using a DLP printer or a SLA printer. Examples of suitable DLP printers include FIG. 4 printers from 3D Systems. The Viper System or the Form 2 printer is an example of an SLA printer that can be used. The settings used to process the photocurable composition in these printers can be easily determined by one of ordinary skill in the art.

One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A photocurable polymer composition for use in a three-dimensional printer comprising:
a photocurable resin;
a filler;
wherein said filler ranges from About 0 to about 30 weight percent of the composition and said photocurable polymer composition has a desired dielectric constant.

2. The composition as recited in claim 1, whereOIN the photocurable resin is an acrylate.

3. The composition as recited in claim 1, wherein the photocurable resin is an olefin.

4. The composition as recited in claim 1, wherein the filler is chosen from the group consisting of inorganic or organic fillers.

5. The composition as recited in claim 3, wherein the inorganic fillers are chosen from the group comprising of mica, titanium dioxide and magnesium oxide.

6. The composition as recited in claim 4, wherein the fillers comprise a mixture of mica and magnesium oxide.

7. A method of preparing a photocurable composition having a desired dielectric constant for use in a three-dimensional printer comprising adding filler to a photocurable resin and dispersing uniformly the filler in such photocurable resin.

8. A part manufactured using a three-dimensional printer using a photocurable composition comprising a photocurable resin with filler dispersed uniformly in such resin to achieve a desired dielectric constant.

9. The composition of claim 1, wherein the photocurable resin is an epoxy.
